(19) United States
(12) Patent Application Publication
(10) Pub. No.: US 2007/0225859 A1
(43) Pub. Date: Sep. 27, 2007

(54) Wardrobe Management System

(75) Inventors: Aleksey Yuryevich Kolesnychenko, Eindhoven (NL); Coen Theodorus Hubertus Fransiscus Liedenbaum, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/568,812

(22) PCT Filed: May 9, 2005
(86) PCT No.: PCT/IB05/51512

§ 371 Date: Nov. 8, 2006

(30) Foreign Application Priority Data
May 13, 2004 (EP) 04300278.1

(51) Int. Cl. G06F 7/00

(52) U.S. Cl. 700/216

(57) ABSTRACT

The invention relates to an intelligent wardrobe management system for advising appropriate clothing to a user. It comprises a wardrobe controller which is arranged to: receive input data, said input data comprising information about the clothing in a wardrobe; receive user data; process said input data and said user data; and output, on the basis thereof, a clothing proposal to the user. The system facilitates and accelerates the user's access to the wardrobe.

### FIELD OF THE INVENTION

The present invention relates to an intelligent wardrobe management system for advising appropriate clothing to a user. It also relates to a method and a computer program for advising appropriate clothing to a user.

### BACKGROUND OF THE INVENTION

Wardrobes for accommodating clothes such as shirts, dresses, skirts, trousers and sweaters are well known. When a user needs a specific item, he has to get to the wardrobe and search among all the different pieces of clothing until he eventually finds what he wants.

U.S. Pat. No. 5,651,677 discloses a wardrobe management system for organizing men's and women's business wardrobes to ensure that no repetition of clothing worn at occasions attended by the same groups of people occurs. The wardrobe management system has a log book in a calendar format with specified areas therein for recording garment identification and alpha-numeric information. The log book stores information about each garment and its prior usage. A marking tag has unique alpha-numeric information and is attached to each garment. The alpha-numeric information is recorded in the log book with a description of the garment or garment accessory to which it is attached. In planning clothing to be worn to future gatherings, the history of use information can be reviewed to avoid repetition of wearing the same garments to sequential and related functions.

However, this system neither takes into account the desires of the user, nor helps in planning the luggage for a trip.

If the specific clothing is not to be found in the wardrobe, e.g. it might be in the laundry, the user has to find a substitute. In case he is going on a trip for several days, he has to first make plans for what kind of and how much clothing he will be in need of, and then he has to find all that clothing in the wardrobe. He always has to see to that the different sets of clothing match. Other factors that influence his choice of clothing are weather forecasts, climate conditions, cultural manner and customs, mode trends. The time duration he will be in need of the clothing is also of importance in his considerations.

However, this process of planning and finding clothing is very time consuming and requires substantial effort. It is well appreciated that people tend to value their time more highly now than in the past. This tendency to more highly valued time nowadays is evidenced by a trend toward modem conveniences. Household appliances, such as washing machines, dishwashers, refrigerators and so on, are time savers that are indispensable to most people.

### SUMMARY OF THE INVENTION

An object of the present invention is therefore to provide a solution to the problem above of planning and finding clothing.

This object is achieved by an intelligent wardrobe management system for advising appropriate clothing to a user according to claim 1, a method for advising appropriate clothing to a user according to claim 13 and a computer program for advising appropriate clothing to a user according to claim 20.

According to a first aspect of the invention, an intelligent wardrobe management system is provided comprising a wardrobe controller which is arranged to receive input data, said input data comprising information about the clothing in a wardrobe, receive user data, process said input data and said user data, and output, on the basis thereof, a clothing proposal to the user.

According to a second aspect of the invention, a method is provided in which input data is received, said input data comprising information about the clothing in a wardrobe, user data is received, said input data and said user data is processed, and, on the basis thereof, a clothing proposal to the user is output.

According to a third aspect of the invention, a computer program product is provided, which is loadable into a digital computer, comprising computer program code portions for carrying out the steps of said method.

In recent years sophisticated household inventions have been made such as intelligent homes, intelligent refrigerators, intelligent vacuum cleaners, wearables and so on. These are all part of an ambient intelligence environment that is sensitive, adaptive, and responsive to the presence of people. The ambient intelligence here means that the home automation system identifies the user and adjusts these functions according to known preferences.

The gist of the invention is to provide an ambient intelligence environment for the user in order to aid him to choose right clothing in accordance with his demands. On the basis of the selection of available clothing in the wardrobe and the user data given by the user, a clothing proposal is suggested to the user. The user data comprises information about the user, such as where he is going, what he will be doing and his planned time schedule.

The above described concept is advantageous in that it facilitates and accelerates the users access to the wardrobe. The user can ease the difficulty of having to make all these frequently recurring choices and he does not have to spend a lot of time looking for the necessary information. A lot of people find these choices hard to make, due to different reasons. Some have a hard time of making their mind up, some do not feel they have the required time, some find it boring, some are just not very capable of finding appropriate combinations of clothing, some are color-blind, and so on. The present invention helps to alleviate the burden of making these choices and speeds up the required process.
According to an advantageous embodiment of the invention, the intelligent wardrobe management system comprises a database in which the received input data is stored. The input data holds information about the clothing contained in the wardrobe such as, for example, the type of clothing, their availability, their color, their age, the season they are adapted to, their state (clean or not), or preferred matching clothing articles. The database also contains user preferences and a wearing history of the respective clothing articles.
According to another advantageous embodiment of the invention, said system comprises at least one scanner, e.g. a camera, a bar-code scanner and/or a tag identification sensor which is arranged to obtain said input data. Each clothing is scanned in order to obtain said input data. If a camera is used, there is a need for using some kind of image recognition software in order to identify the clothing articles going in and out of the wardrobe. In the future the clothing articles might be provided with a chip or some other information holder which stores all the information about the clothing articles.

According to yet another advantageous embodiment of the invention, said system comprises a user interface, whereby at least one of said reception of user data and said output of clothing advice is performed. Preferably, the user interface comprises a communication interface such as a touch display, a keyboard or the like for entering the user data. Further, the user interface preferably comprises a visual display for displaying said clothing advice.

According to yet another advantageous embodiment of the invention, said system comprises a network interface which is arranged to connect the system to at least one network. Such a network is, for example a World Area Network (WAN) such as Intranet and Internet or a Local Area Network (LAN). In this way the information about the clothing in the wardrobe is remotely accessible. The user doesn't have to go to the wardrobe in order to the enter the user data and receive said clothing proposal, but he can do it from another room in the building, or even from any part of the world that has access to the network.

Further, information goes also in the opposite direction. Said system has access to information outside the system through said network. In case there is a missing wanted clothing piece, it is possible for the user to order said clothing piece over the network in order to complete the wardrobe. Information, such as weather forecasts, climate conditions, cultural conditions and mode trends with reference to any place on earth, is also obtainable through said network.

According to yet another advantageous embodiment of the invention, said system comprises information about a location that the user is to visit, and information about circumstances regarding the visit, which circumstances affect the clothing. When the user, for example, plans to go on a trip to one place or to several places, he can get very useful information, through said system, about those places. Information, such as weather forecasts, climate conditions, cultural conditions and mode trends, may affect his choice of clothing. If, for example, the user is going to a dinner with French businessmen, he can receive good advices about what to wear in order not to stand out too much in consideration to what French businessmen usually wear. Said system is arranged to obtain all the information above, e.g. through the network, for example Intranet and/or Internet.
Further, said system comprises information about a duration of said visit during which the user will be in need of clothing. The time spent away affects the amount of needed clothing. In case the user is going to spend several days away from home, he will be in need of a great deal of clothing. In order to reduce the amount of needed clothing, the system is capable of suggesting some co-ordination advantages, i.e. some of the clothing articles may be used more than once—in a new combination.

Further features of, and advantages with, the present invention will become apparent when studying the appended claims and the following description. Those skilled in the art realize that different features of the present invention can be combined to create embodiments other than those described herein. Many different alterations, modifications and combinations will become apparent for those skilled in the art. The described embodiments are therefore not intended to limit the scope of the invention, as defined by the appended claims.

### BRIEF DESCRIPTION OF THE DRAWINGS

The present invention will now be described in more detail, by way of example, with reference to the accompanying drawings, wherein:

FIG. 1 shows a schematic representation of an intelligent wardrobe management system according to the present invention.

### DETAILED DESCRIPTION OF THE INVENTION

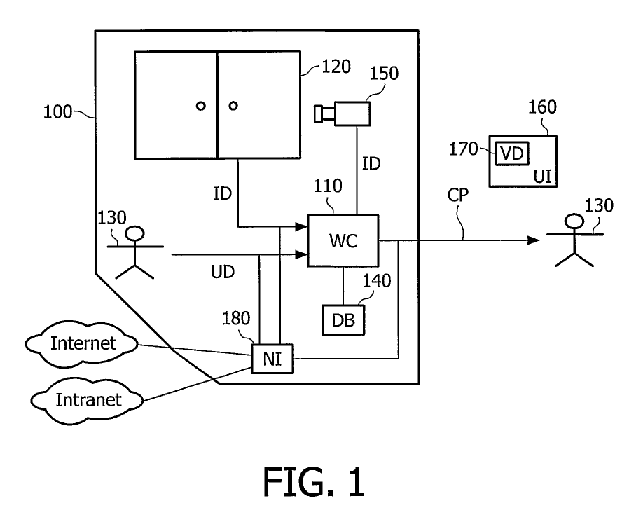

FIG. 1 shows a schematic representation of an intelligent wardrobe management system 100 according to the present invention. The intelligent wardrobe management system 100 comprises a wardrobe 120 which contains diverse clothing articles. A camera 150 is used for scanning the clothing in the wardrobe 120 in order to gather information about the clothing. The clothing articles are shown in a frontal view to the camera 150 before being folded or hung up in the wardrobe 120. The same procedure applies when taking them out. The camera 150 may be positioned on the outside or the inside of the actual wardrobe 120. In an alternative embodiment, the wardrobe 120 houses an “in-out” compartment where the scanning takes place. In order to identify the clothing articles going in and out of the wardrobe 120, an image recognition software is used. The information thus obtained represents input data (ID) and is received by a wardrobe controller 110. The wardrobe controller 110 stores said input data in a database (DB) 140.

The question “What am I supposed to wear today or what should I take with me on a business trip?” is very familiar to many people. In the following example, a business trip abroad will be undertaken in order to demonstrate this embodiment of the intelligent wardrobe management system according to the present invention.

A user 130 is going on a business trip to Japan and New Zealand for several days. In New Zealand he will be playing golf during one of the days. On his way home he will join his family on a ski holiday in the Swiss Alps. From thence they will travel to London in order to attend a wedding, before they finally go home. The user 130 is well in advance, the journey starts in a couple of days, and he is planning what clothing articles he should bring. He logs on from a user interface (UI) 160, which in this case is a user terminal. The user terminal is, for example, located in the kitchen. The user interface (UI) 160 has access, through a network interface (NI) 180, to a network of his house, for instance an Intranet network and it can thus establish a connection with the intelligent wardrobe management system 100. He enters his user data (UD), for example comprising where he is going, what he will be doing and his planned time schedule.

The wardrobe controller 110 considers said received user data and searches on a WAN, for example on the Internet, for additional information such as weather forecasts, climate conditions, cultural conditions and mode trends which are associated with said locations that he is to visit and said events that he is to attend, in accordance with his time schedule. The wardrobe controller 110 finds out several factors, which are of great importance and influence the choice of clothing. The Japanese business dress code is very strict. Even though the user always favors colored shirts, they are totally out of place in this case—a white shirt with a conservative suit and tie are indispensably required. An unexpected rain weather is predicted in the area in New Zealand where he will be playing golf, so appropriate rain clothes will be needed. The holiday resort area where he will be skiing with his family, holds a great adventure bath place. Bathing attire will thus come in handy. Between Gatwick airport in London and the place of the wedding there are a couple of formal-wear shops where he can rent a tuxedo.

The wardrobe controller 110 processes said input data and said user data and outputs, on the basis thereof, a clothing proposal CP to the user 130. He receives a summarized list telling him what bring. He also receives an event specified list telling him what to wear for the different events. It is suggested to him, in order to reduce the weight and size of the luggage, that he could reuse some of the clothing articles. He could, for example, use his jackets and trousers in diverse combinations. Since he is in need of a couple new white shirts, it is proposed to him to order said shirts over the Internet from a warehouse. The order is thus handled by the wardrobe controller 110 on user authorization.

Considering his travel plans and the surrounding circumstances, he is admonished to bring, among other things, his gray and blue suits, several dark ties, his rain clothes and his pair of galoshes, his swimming hunks and his bathrobe. He is asked the question if he wants to place an order for a tuxedo and, if affirmative, he can choose between the different alternatives.
The clothing proposal is shown on a visual display VD 170. He can always select other clothing articles by browsing through different alternatives. Being color-blind he appreciates the help he gets, otherwise it would have been a lot harder to choose a proper set of clothing. He is presented with the option of having the clothing advice to be shown on the visual display in such a way that he appears to be dressed with the suggested clothing proposal.

The day before he is to leave he logs on to the intelligent wardrobe management system 100 over a WAN, for example the Internet, from work. He finds out that a couple of desired lacking items are now on place in his wardrobe. The ordered new white shirts have arrived and the trousers have returned from the laundry. He also finds out that weather prognosis for the day of the golfing still applies. Further, he receives a confirmation from the formal-wear shop that the chosen tuxedo is reserved for him.

In an alternative embodiment of the present invention, the scanner is a bar-code scanner or a tag identification sensor, which could be used for gathering information, i.e. input data (ID), about the clothing. This requires that the clothing articles are equipped with bar codes and identification tags, respectively. In case they identify type, color, size and so on of the clothing, the gathering of information is considerably facilitated. When the user 130 puts clothing in the wardrobe 120 and scans the clothing by means of said scanning devices, they are consequently identified and said input data (ID) is stored in the database (DB) 140. If the clothing is equipped with some kind of intelligent sensor, in the form of e.g. a chip, the information of the clothing may, for example, also include their state (clean or not) or their using time, i.e. the actual amount of time they have been worn. The wardrobe controller 110 may, for example, propose to send a pair of trousers, which needs to be cleaned, to the laundry.

In another alternative embodiment of the present invention, the intelligent wardrobe management system 100 has access to the user's 130 digital time schedule. In this way the wardrobe controller 110 can automatically obtain a lot of the user data UD.

In another alternative embodiment of the present invention, the user has the option of entering his preferences regarding his clothing articles and his clothing style. This information is stored in the database 140 and is optionally considered. The database keeps a wearing history of the respective clothing articles and the clothing articles used longest time ago appears with priority, but if the user turns it down a certain amount of times, it is put on hold. The system is adapted to propose a list of these clothing articles to be removed from the wardrobe. The clothing articles most frequently used are assigned with a prioritized state, i.e. they belong to the users preferences. This applies not only to the single clothing articles, but also to the combinations of clothing articles used.

In conclusion, and by way of summary, an advantage of the present invention is that it facilitates and accelerates the user's access to the wardrobe. The intelligent wardrobe management system obtains all necessary information about the clothing, the user and the locations that the user is to visit and it proposes what to wear or what to bring on a trip. He can thus ease the difficulty of having to make all the frequently recurring choices of choosing clothing and he does not have to spend a lot of time looking for the necessary information.

It should be noted that the above-mentioned embodiments exemplify the invention, and that those skilled in the art will be able to design many alternative embodiments without departing from the scope of the appended claims. For example, the realisation and implementation of the present invention, at least to a certain extent, may be in the form of either separate elements or computer software. The word “comprising” does not exclude the presence of elements or steps other than those listed in a claim. The word “a” or “an” preceding an element does not exclude the presence of a plurality of such elements.

1. An intelligent wardrobe management system for advising appropriate clothing to a user, characterized in that it comprises a wardrobe controller which is arranged to:
receive input data, said input data comprising information about the clothing in a wardrobe;
receive user data;
process said input data and said user data; and
output, on the basis thereof, a clothing proposal to the user.

2. An intelligent wardrobe management system according to claim 1, comprising a database wherein said received input data is stored.

3. An intelligent wardrobe management system according to claim 1, comprising at least one scanner which is arranged to obtain said input data.

4. An intelligent wardrobe management system according to claim 1, wherein said system comprises a user interface, whereby at least one of said reception of user data and said output of clothing proposal is performed.

5. An intelligent wardrobe management system according to claim 4, wherein said user interface comprises a visual display for displaying said clothing proposal.

6. An intelligent wardrobe management system according to claim 1, comprising a network interface which is arranged to connect the system to at least one network.

7. An intelligent wardrobe management system according to claim 6, wherein at least one of said input data, said user data and said clothing proposal is communicated through said network interface.

8. An intelligent wardrobe management system according to claim 6, arranged for ordering a specific clothing piece over said network interface in order to complete the wardrobe.

9. An intelligent wardrobe management system according to claim 1, wherein said received user data comprises information about a location that the user is to visit, and/or information about circumstances regarding the visit, which circumstances affect the clothing and/or information about a duration of said visit during which the user will be in need of clothing.

10. A method for advising appropriate clothing to a user, characterized in that it comprises the steps of:
receiving input data, said input data comprising information about the clothing in a wardrobe;
receiving user data;
processing said input data and said user data; and
outputting, on the basis thereof, a clothing proposal to the user.

11. A computer program product, loadable into a digital computer, comprising computer program code portions for carrying out the steps of the method as claimed in claim 10.
